(19) United States
(12) Patent Application Publication
(10) Pub. No.: US 2025/0247878 A1
(43) Pub. Date: Jul. 31, 2025

(54) Ranking User Equipment and Bearers

(71) Applicant: Dell Products, L.P., Round Rock, TX (US)

(72) Inventors: Chethan Kumar Thandramaradahalli Earappa, Stittsville (CA); Devang Manoj Sharma, Vancouver (CA); Rahul Kumar Mishra, Nepean (CA); Manbir Kaur, Brampton (CA); Ravi Sharma, Cupertino, CA (US); Satish Venkob, Mississauga (CA)

(21) Appl. No.: 18/423,031

(22) Filed: Jan. 25, 2024

(51) Int. Cl. H04W 72/566; H04W 28/02; H04W 28/16; H04W 72/121

(52) U.S. Cl. CPC H04W 72/566; H04W 28/0252; H04W 28/16; H04W 72/121

(57) ABSTRACT

A system can, for respective user equipment (UE) of a group of UE for which broadband cellular communications are being facilitated via a network comprising the system, determine respective establishment causes, determine respective bearer types, and determine respective priority levels, wherein a first weight associated with the respective establishment causes is greater than a second weight associated with the respective bearer types, which is greater than a third weight associated with a priority level. The system can rank the respective UE based on the respective establishment causes, the respective bearer types, the respective priority levels, the first weight, the second weight, and the third weight to produce respective rankings of the respective user equipment. The system can, in response to determining that a serving-capacity criterion is satisfied with respect to the group of UE and based on the respective rankings, prioritize service offered to the respective UE.

### BACKGROUND

A base station can facilitate broadband cellular communications with user equipment.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can, for respective user equipment of a group of user equipment for which broadband cellular communications are being facilitated via a network comprising the system, determine respective establishment causes, determine respective bearer types, and determine respective priority levels, wherein a first weight associated with the respective establishment causes is greater than a second weight associated with the respective bearer types, and wherein the second weight is greater than a third weight associated with a priority level. The system can rank the respective user equipment based on the respective establishment causes, the respective bearer types, the respective priority levels, the first weight, the second weight, and the third weight to produce respective rankings of the respective user equipment. The system can, in response to determining that a serving-capacity criterion is satisfied with respect to the group of user equipment and based on the respective rankings, prioritize service offered to the respective user equipment.

An example method can comprise determining, by a system comprising a processor, an inventory of hardware deployed in a telecommunications cloud deployment.

The method can further comprise facilitating, by a system, broadband cellular communications with a group of user equipment. The method can further comprise, for each user equipment of the group of user equipment, determining, by the system, a respective establishment cause, a respective bearer type, and a respective priority level. The method can further comprise ranking, by the system, each of the user equipment of the group of user equipment based on the respective establishment cause, the respective bearer type, and the respective priority level to produce ranks. The method can further comprise, in response to determining that a serving-capacity criterion is satisfied with respect to the group of user equipment, prioritizing, by the system, service offered to the respective user equipment based on the ranks.

An example non-transitory computer-readable medium can comprise instructions that, in response to execution, cause a system comprising a processor to perform operations. These operations can comprise, for respective user equipment of a group of user equipment, determining respective establishment causes, respective bearer types, and respective priority levels. The operations can further comprise ranking the respective user equipment based on the respective establishment causes, the respective bearer types, and the respective priority levels to produce respective ranks. The operations can further comprise, in response to determining that a serving-capacity criterion is satisfied with respect to the group of user equipment, prioritizing respective services offered to the respective user equipment based on the respective ranks.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate ranking user equipment and bearers, in accordance with an embodiment of this disclosure;

FIG. 2 illustrates an example process flow for a gNodeB running at high load without a ranked UE list, and that can facilitate ranking user equipment and bearers, in accordance with an embodiment of this disclosure;

FIG. 3 illustrates an example table of an establishment cause priority, and that can facilitate ranking user equipment and bearers, in accordance with an embodiment of this disclosure;

FIG. 4 illustrates an example table of a resource type priority, and that can facilitate ranking user equipment and bearers, in accordance with an embodiment of this disclosure;

FIG. 5 illustrates an example table of a fifth generation quality-of-service (QoS) identifier (5Q1) data set for a ranking methodology, and that can facilitate ranking user equipment and bearers, in accordance with an embodiment of this disclosure;

FIG. 6 illustrates an example table of ranking parameter weights, and that can facilitate ranking user equipment and bearers, in accordance with an embodiment of this disclosure;

FIG. 7 illustrates an example table of bearer rankings, and that can facilitate ranking user equipment and bearers, in accordance with an embodiment of this disclosure;

FIG. 8 illustrates an example table of UE rankings, and that can facilitate ranking user equipment and bearers, in accordance with an embodiment of this disclosure;

FIG. 9 illustrates an example table of a bearer rank data set for a UE, and that can facilitate ranking user equipment and bearers, in accordance with an embodiment of this disclosure;

FIG. 10 illustrates an example table of UE ranking, and that can facilitate ranking user equipment and bearers, in accordance with an embodiment of this disclosure;

FIG. 11 illustrates an example table of a UE rank data set, and that can facilitate ranking user equipment and bearers, in accordance with an embodiment of this disclosure;

FIG. 12 illustrates an example table of a UE rank update due to a bearer addition, and that can facilitate ranking user equipment and bearers, in accordance with an embodiment of this disclosure;

FIG. 13 illustrates an example table of a UE rank update due to a bearer deletion, and that can facilitate ranking user equipment and bearers, in accordance with an embodiment of this disclosure;

FIG. 14 illustrates an example process flow for a gNodeB running at high load with a ranked UE list, and that can facilitate ranking user equipment and bearers, in accordance with an embodiment of this disclosure;

FIG. 15 illustrates an example process flow that can facilitate ranking user equipment and bearers, in accordance with an embodiment of this disclosure;

FIG. 16 illustrates another example process flow that can facilitate ranking user equipment and bearers, in accordance with an embodiment of this disclosure;

FIG. 17 illustrates another example process flow that can facilitate ranking user equipment and bearers, in accordance with an embodiment of this disclosure;

FIG. 18 illustrates an example block diagram of a computer operable to execute an embodiment of this disclosure.

### DETAILED DESCRIPTION

### Overview

In a disaggregated architecture of fifth-generation (5G) radio access network (RAN), depending on a hierarchy, a gNodeB (sometimes referred to as a base station or a gNB) can comprise a centralized unit control plane (CUCP), multiple centralized unit user planes (CUUPs), and distributed units (DUs) that are interconnected. Each DU can comprise several cells. Each of these cells can be connected to thousands of user equipments (UEs) in a macro deployment. As the number of UEs increase, there can be numerous challenges to mitigate at CUCP. Some of these challenges can be:
System capacity is reached;
Overload situation detected at gNodeB (e.g., central processing unit (CPU)/Memory); and
Link Loss between components.

In all the above scenarios, a gNodeB can be aided by having a readily-available sorted list of UEs in real-time, allowing it to make intelligent, fair, and more accurate decisions, relative to prior approaches. It can be that, in existing 5G new radio (NR) 3^{rd} generation partnership project (3GPP) specifications, there is no standardized way to prioritize UEs to address these problems. While the present examples generally deal with 5G implementations, it can be appreciated that the present techniques can be applied to other types of broadband cellular communications,

The present techniques can be implemented to produce an efficient real-time “UE and Data Radio Bearer (DRB) Qualitative Ranking” mechanism for the users connected to a gNodeB. This mechanism can consider important attributes of UEs and bearers to derive a discrete “Bearer Rank” for each bearer within a UE. And these can be utilized to determine a “UE Rank”. A UE Rank can be used in maintaining a priority list of UEs/DRBs within a gNodeB. Additionally, the present techniques can be implemented to update ranks upon addition/modification/deletion of a bearer and its attributes.

Returning to challenges in mitigating at CUCP as the number of UEs increases, in each of the above scenarios, a gNodeB can make decisions regarding UE admission control, load balancing, and redistribution of existing UEs from one CUUP to another. While making these decisions, it can be that a gNodeB operates fairly amongst all the UEs connected to it, and incoming priority users (e.g., a UE with radio resource control (RRC) Establishment Cause: Emergency). Without a ranked list of UEs, there can be fairness issues.

Examples of such scenarios can be as follows. One example scenario can involve UE preemption. When system capacity is reached, and if there is an incoming emergency user to admit, in an absence of a ranked list of UEs, if a gNodeB decides to preempt an existing UE randomly, there can be a chance that a high-priority UE is released.

Another example scenario can involve congestion control. When an overload condition is detected in a gNodeB, and UEs are to be released to mitigate this situation, higher-priority users can get released instead of low-priority ones.

Another example scenario can involve UE relocation or redistribution. When a link loss is detected between components, it can be that a gNodeB cannot take a fair decision to relocate high-priority UEs to other serving components. For example, if a link loss is detected between CUCP and CUUP, it can be that UEs can be relocated from one CUUP to another CUUP that is connected to the same CUCP.

### Example Architectures, Process Flow, and Tables

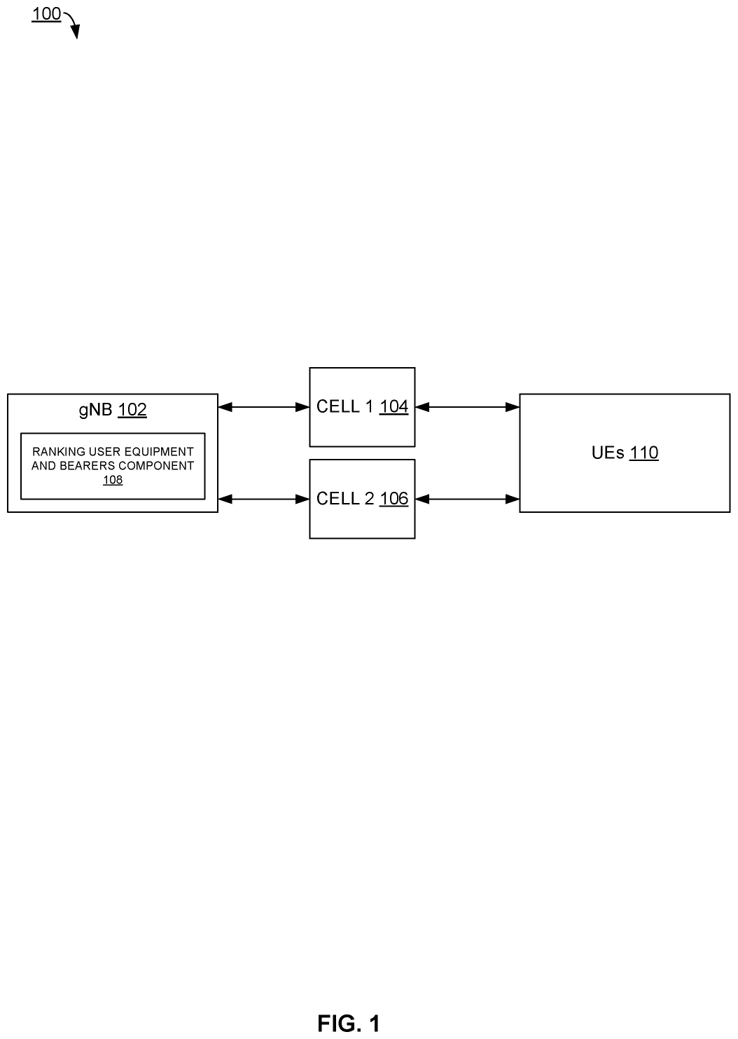

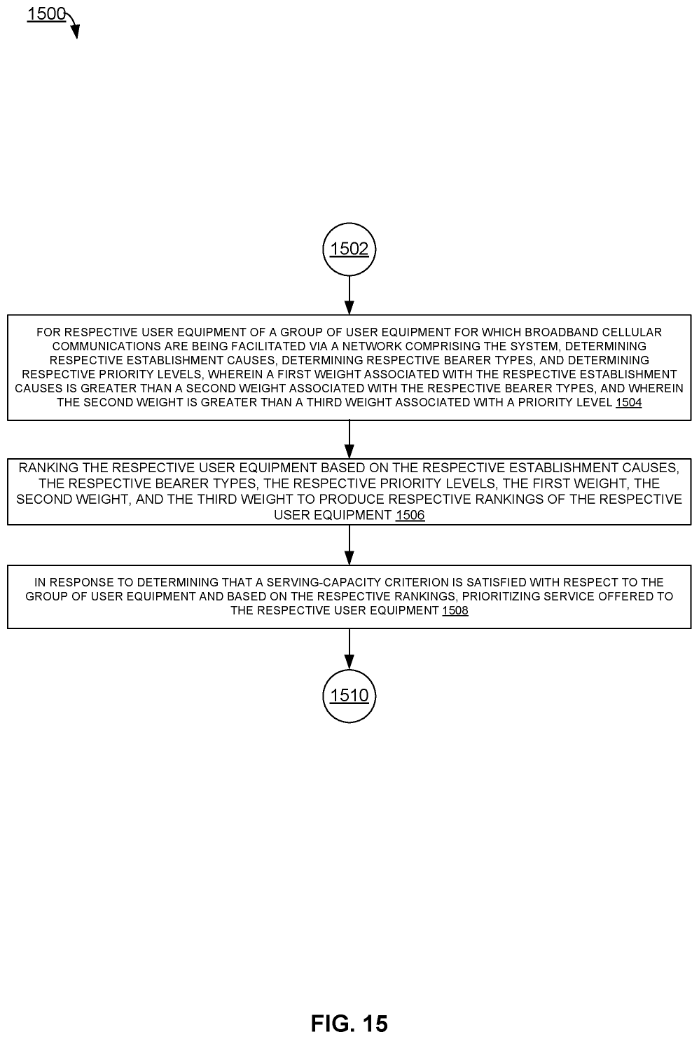

FIG. 1 illustrates an example system architecture 100 that can facilitate ranking user equipment and bearers in accordance with an embodiment of this disclosure. In some examples, part(s) of system architecture 100 can be used to implement the example process flows of FIGS. 15-17.

In cellular communications, there can be a master cell group (MCG) to which a UE initially registers. In some examples, communications with a UE can be conducted via multiple cells (which can generally involve combining multiple carriers to increase bandwidth available to UEs), which can be referred to here as cell 1 and cell 2.

The examples herein generally relate to 5G cellular communications networks. It can be appreciated that the present techniques can be applied to other types of cellular communications networks for ranking UEs and bearers.

As depicted, system architecture 100 comprises gNodeB (gNB) 102, cell 1 104, cell 2 106, ranking user equipment and bearers component 108, and UEs 110

gNB 102 can generally comprise a cellular fifth-generation (5G) base station, can comprise multiple antennas, and can concurrently communicate with multiple instances of UE 110. UE 110 can generally comprise a computing device that is configured to be used directly by an end-user to communicate with gNB 102. Cell 1 104 and cell 2 106 can each be communicatively coupled to both gNB 102 and UE 110.

Ranking user equipment and bearers component 108 can generally comprise a component of gNB 102 that facilitates ranking user equipment and bearers for gNB 102 as described herein.

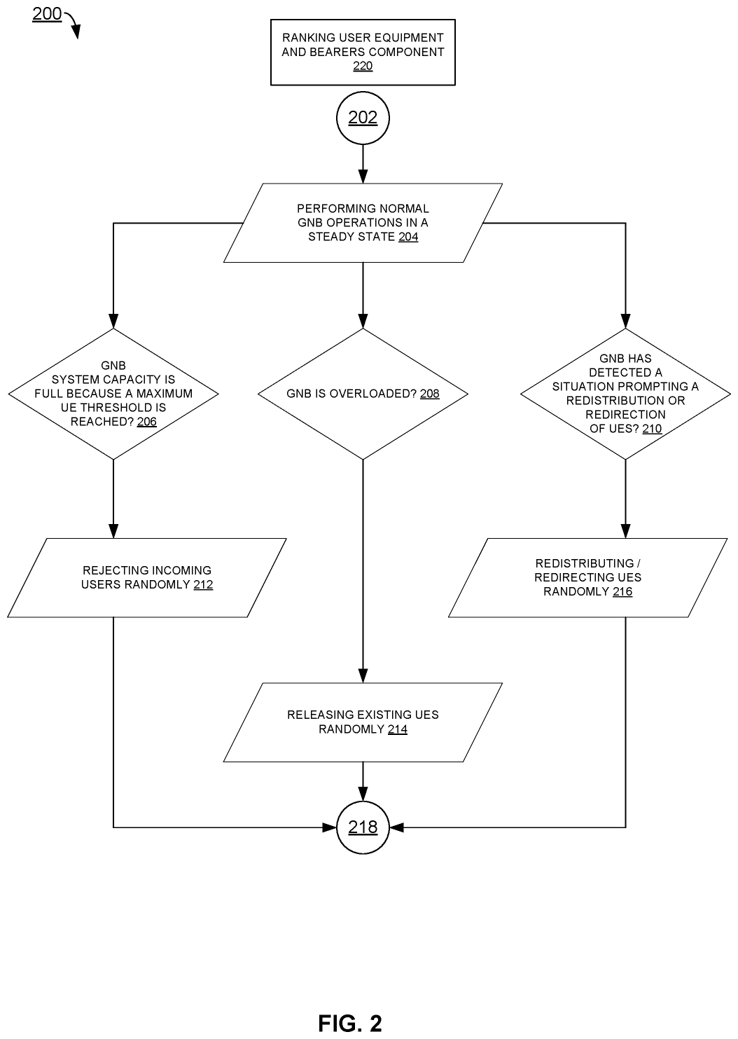

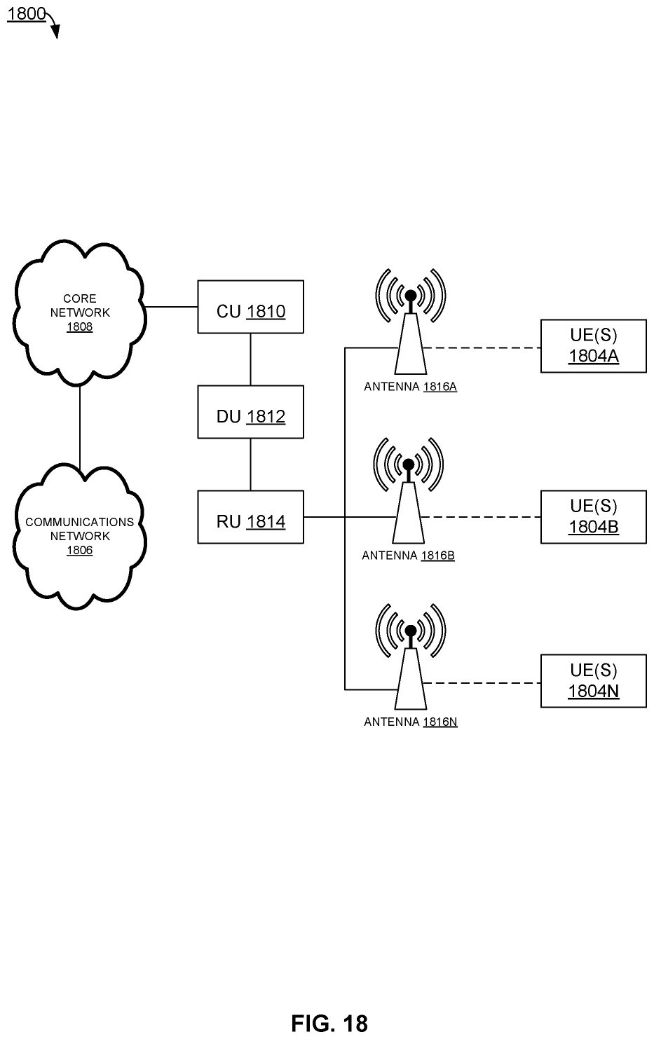

FIG. 2 illustrates an example process flow 200 for a gNodeB running at high load without a ranked UE list, and that can facilitate ranking user equipment and bearers, in accordance with an embodiment of this disclosure. In some examples, one or more embodiments of process flow 200 can be implemented by ranking user equipment and bearers component 108 of FIG. 1, ranking user equipment and bearers component 220 (which can be similar to ranking user equipment and bearers component 108), or computing environment 1800 of FIG. 18.

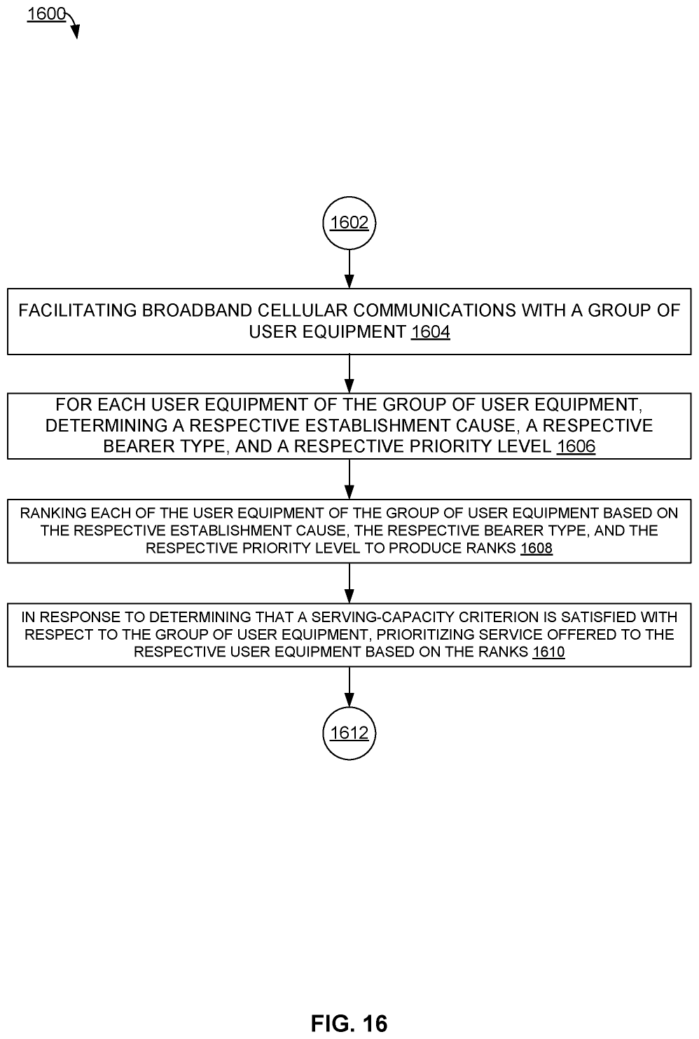

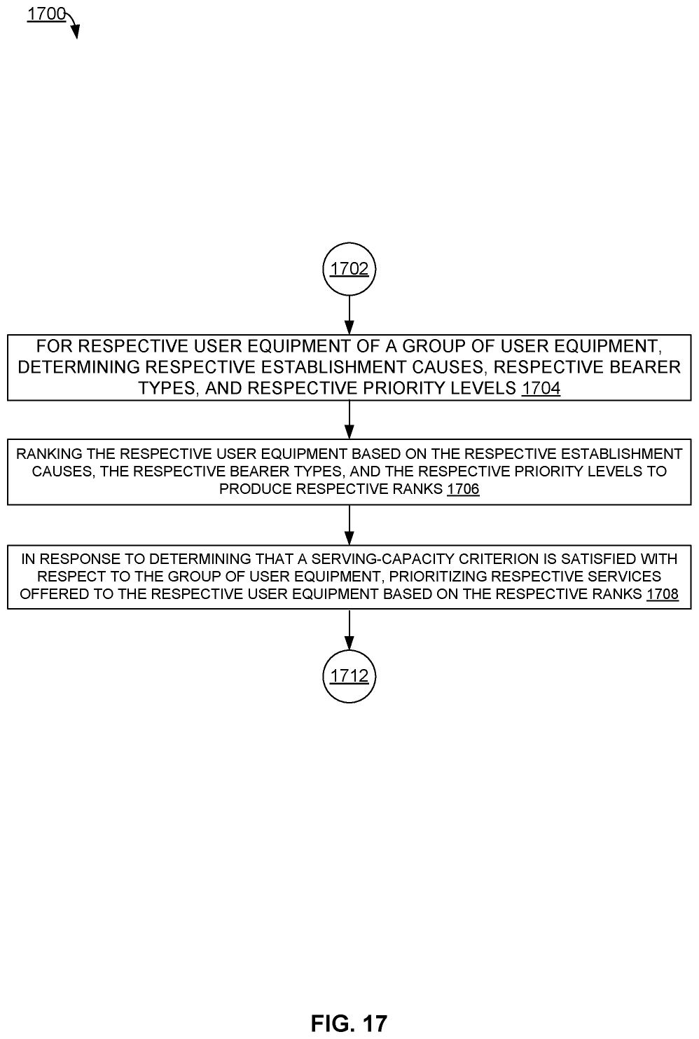

It can be appreciated that the operating procedures of process flow 200 are example operating procedures, and that there can be embodiments that implement more or fewer operating procedures than are depicted, or that implement the depicted operating procedures in a different order than as depicted. In some examples, process flow 200 can be implemented in conjunction with one or more embodiments of one or more of process flow 1500 of FIG. 15, process flow 1600 of FIG. 16, and/or process flow 1700 of FIG. 17.

Process flow 200 begins with 202, and moves to operation 204.

Operation 204 depicts performing normal gNB operations in a steady state.

After operation 204, process flow 200 moves to operation 206, 208, or 210, depending on a condition that is detected.

Operation 206 depicts determining whether gNB system capacity is full because a maximum UE threshold is reached.

An example scenario can involve UE preemption. When system capacity is reached, and if there is an incoming emergency user to admit, in an absence of a ranked list of UEs, if a gNodeB decides to preempt an existing UE randomly, there can be a chance that a high-priority UE is released.

After operation 206, process flow 200 moves to operation 212.

Operation 208 depicts determining whether the gNB is overloaded. This can comprise gNB system resources such as central processing unit (CPU) and memory being almost full.

Another example scenario can involve congestion control. When an overload condition is detected in a gNodeB, and UEs are to be released to mitigate this situation, higher-priority users can get released instead of low-priority ones.

After operation 208, process flow 200 moves to operation 214.

Operation 210 depicts determining whether the gNB has detected a situation prompting a redistribution or redirection of UEs.

Another example scenario can involve UE relocation or redistribution. When a link loss is detected between components, it can be that a gNodeB cannot take a fair decision to relocate high-priority UEs to other serving components. For example, if a link loss is detected between CUCP and CUUP, it can be that UEs can be relocated from one CUUP to another CUUP that is connected to the same CUCP.

After operation 210, process flow 200 moves to operation 216.

Operation 212 depicts rejecting incoming users randomly.

After operation 212, process flow 200 moves to 218, where process flow 200 ends.

Operation 214 depicts releasing existing UEs randomly.

After operation 214, process flow 200 moves to 218, where process flow 200 ends.

Operation 216 depicts redistributing/redirecting UEs randomly.

After operation 216, process flow 200 moves to 218, where process flow 200 ends.

In contrast to process flow 200 where a UE ranking list is not implemented, according to the present techniques, a gNodeB can dynamically build and maintain a sorted list of UEs based on ranks, and this list is available during the life cycle of a gNodeB, then the gNodeB can make informed, unbiased, and fair decisions in these- and other-situations.

Other problems with prior approaches can be as follows. A 5G NR gNodeB can interact with thousands of UEs, which get registered for voice and data services, based on dynamic situations. It can be that the gNodeB needs to select some UEs amongst the thousands, to either pre-empt, release, or relocate.

In some examples where a UE ranking mechanism is not implemented, there can be an unfair selection of UEs by a gNodeB, such as in a pre-emption of a UE to admit a high priority UE when a system capacity is reached; a release of a UE when an overload scenario is detected at the gNodeB (e.g., central processing unit (CPU) or memory) to free resources; or a relocation of UEs when link loss between components is detected.

The present techniques can be implemented to mitigate against shortcomings associated with an absence of ranking UEs and/or DRBs. In implementing the present techniques, a choice of qualitative attributes of a UE and DRB can be selected for determining their ranks. In implementing the present techniques, weights of these chosen attributes can be determined based on a degree of their qualitative influence on a UE and/or DRB. In implementing the present techniques, a bearer/DRB rank can be determined. In implementing the present techniques, a UE rank can be determined. In implementing the present techniques, dynamic UE and DRB rank updates can be performed.

An RRC establishment cause (e.g., emergency, high-priority-access, mobile originated (MO)—voice) can identify a type of a UE in a 5G network. In addition, there can be attributes for DRBs within a PDU session negotiated between a UE and 5GC during the protocol data unit (PDU) session and the DRB establishment procedures. A combination of these attributes can signify aspects such as, a type of UE (e.g., emergency, high-priority-access, MO-voice) based on RRC connection; a type of traffic that flows on the bearer (e.g., voice, data, or internet protocol multimedia subsystem (IMS) signaling); a quality of service (QoS) that packets experience end to end (E2E), and a priority level.

The present techniques can be implemented to select key attributes that can help to qualitatively distinguish a DRB and a UE, associate weights to those attributes based on their degree of qualitative influence on DRB behavior, and incorporate them into a weighted average to determine a “bearer rank” for the DRB. Each DRB can receive a distinct rank based on these attributes, and a minimum value for all DRBs within a UE can be chosen as a rank for this subscriber.

Selecting UE and DRB attributes for a ranking can be implemented as follows. In some examples, key attributes of UEs and DRBs can be selected that have a significant qualitative influence on UE/DRB behavior, and they can be dimensioned to determine bearer ranks and UE ranks. A bearer rank can comprise a relative qualitative rank among bearers, and a UE rank can comprise a relative qualitative rank among UEs that are attached to a gNB.

UE establishment cause can be handled as follows. A RRC establishment cause can be a UE level attribute. Such a cause can be as follows, where each cause indicates a nature/criticality of the incoming UE:

```
EstablishmentCause ::= ENUMERATED {
  emergency, highPriorityAccess, mt-Access,
  mo-Signalling, mo-Data, mo-VoiceCall, mo-VideoCall,
  mo-SMS, mps-PriorityAccess, mcs-PriorityAccess, spare6, spare5,
spare4, spare3, spare2, spare1}
```

In some examples, this UE establishment cause can be similar to that of a 3GPP specification, and it can be appreciated that the present techniques can be implemented in conjunction with other standards or independently of a particular standard.

Additionally, even where standards do not define the establishment cause for the incoming handover UEs, the present techniques can be implemented to identify and prioritize them compared to other incoming UEs with establishment causes mentioned above. A reason for this can be that handover (HO) UEs can have spent significant resources, radio bandwidth, etc. before reaching the current gNodeB.

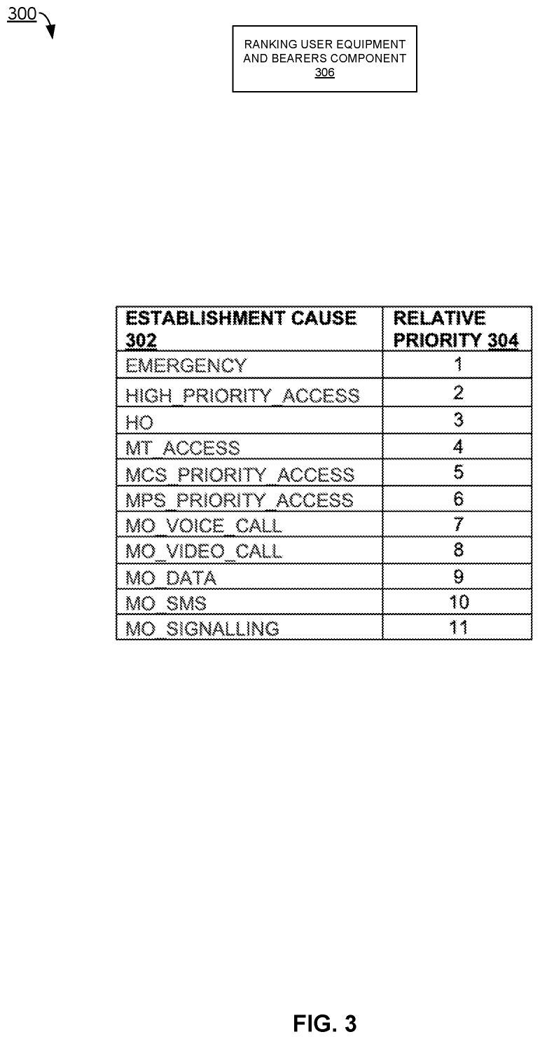

FIG. 3 illustrates an example table 300 of an establishment cause priority, and that can facilitate ranking user equipment and bearers, in accordance with an embodiment of this disclosure. In some examples, parts of table 300 can be used by ranking user equipment and bearers component 108 of FIG. 1, or ranking user equipment and bearers component 306 (which can be similar to ranking user equipment and bearers component 108), as part of facilitating ranking user equipment and bearers.

Table 300 comprises establishment cause 302 and relative priority 304.

The present techniques can be implemented to incorporate an establishment cause relative priority table, such as table 300. This table can help in determining the relative priority of UEs.

For example, a UE with establishment cause as EMERGENCY can be the highest priority UE. Hence its relative priority can be 1, where 1 is the highest priority and 11 is the lowest.

In some examples, the attribute Establishment Cause Priority can be referred to herein as A1 for use in computing Bearer Rank.

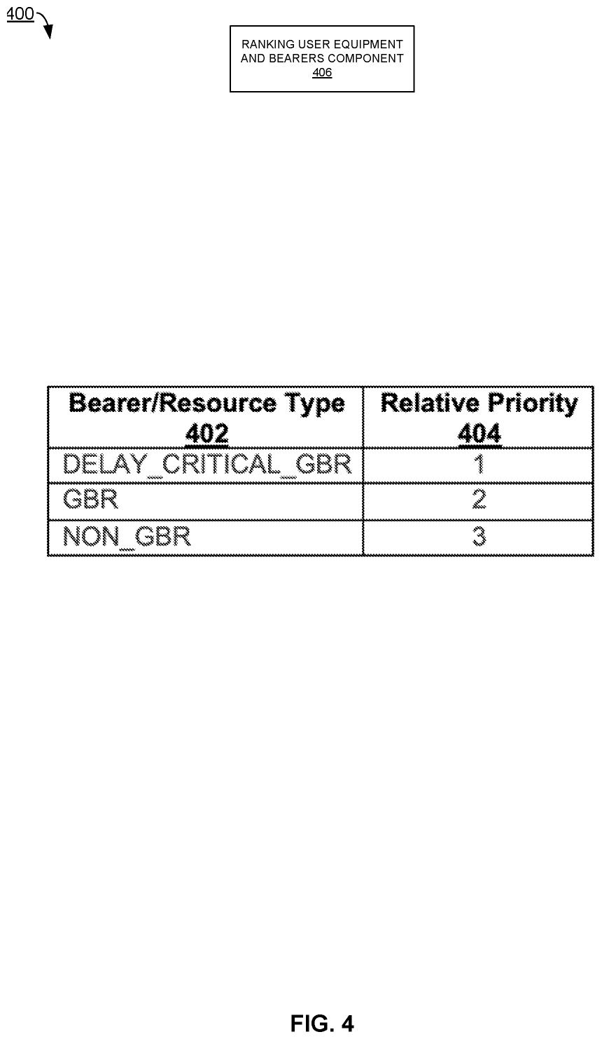

FIG. 4 illustrates an example table 400 of a resource type priority, and that can facilitate ranking user equipment and bearers, in accordance with an embodiment of this disclosure. In some examples, parts of table 400 can be used by ranking user equipment and bearers component 108 of FIG. 1, or ranking user equipment and bearers component 406 (which can be similar to ranking user equipment and bearers component 108), as part of facilitating ranking user equipment and bearers.

Table 400 comprises bearer/resource type 402 and relative priority 404.

Bearer/resource type can be handled as follows. It can be classified into three categories: delay critical guaranteed bit rate (GBR), GBR, and non-GBR. This can signify the type of treatment the traffic experiences on the respective bearer, and hence it can be an important qualitative attribute of a bearer.

The present techniques can be implemented to maintain this resource type relative priority table that categorizes the bearer/resource types with their relative priority.

For example, a Delay Critical GBR type bearer can have a best relative priority compared to Guaranteed Bit Rate Bearers and Non-Guaranteed Bit Rate Bearers

In some examples, the attribute Resource Type Priority can be referred to herein as A2 for use in computing Bearer Rank.

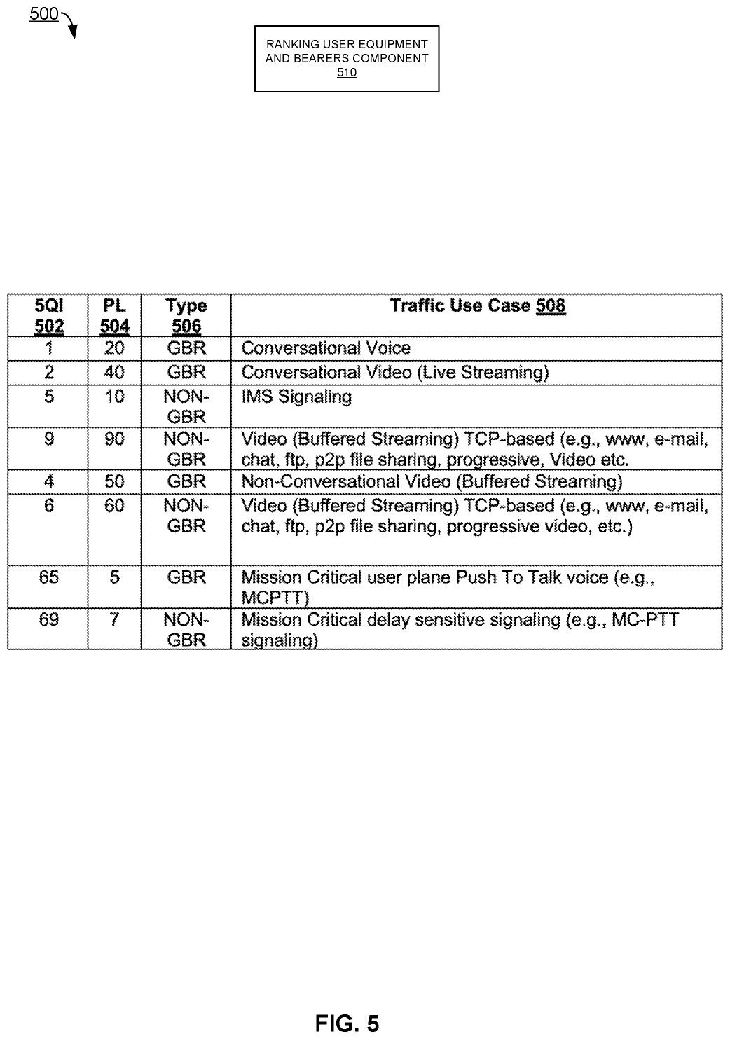

FIG. 5 illustrates an example table 500 of a fifth generation quality-of-service (QoS) identifier (5Q1) data set for a ranking methodology, and that can facilitate ranking user equipment and bearers, in accordance with an embodiment of this disclosure. In some examples, parts of table 500 can be used by ranking user equipment and bearers component 108 of FIG. 1, or ranking user equipment and bearers component 510 (which can be similar to ranking user equipment and bearers component 108), as part of facilitating ranking user equipment and bearers.

Table 500 comprises 5Q1 502, priority level (PL) 504, resource type 506, and traffic use case 508.

Priority Level can be handled as follows. A Priority Level can comprise a bearer level attribute, and can be identified as an important parameter since it can signify end-to-end (E2E) packet treatment for the bearer.

In some examples, a Priority Level of a QOS flow can range from 1 to 127, where 1 is the highest priority and 127 is the lowest priority.

Table 500 illustrates example 5QI values, corresponding Resource Type, Priority Level, and traffic use cases.

This below sample profile of bearers can be used in a simulation of a bearer and a UE ranking methodology.

In some examples, the attribute Priority Level can be referred to herein as A3 for use in computing Bearer Rank.

As described herein, it can be that a Priority Level for a bearer that is specified by a core network can be used to determine Bearer Rank. In examples where such a Priority Level is not specified, it can be that a Default Priority Level is then used.

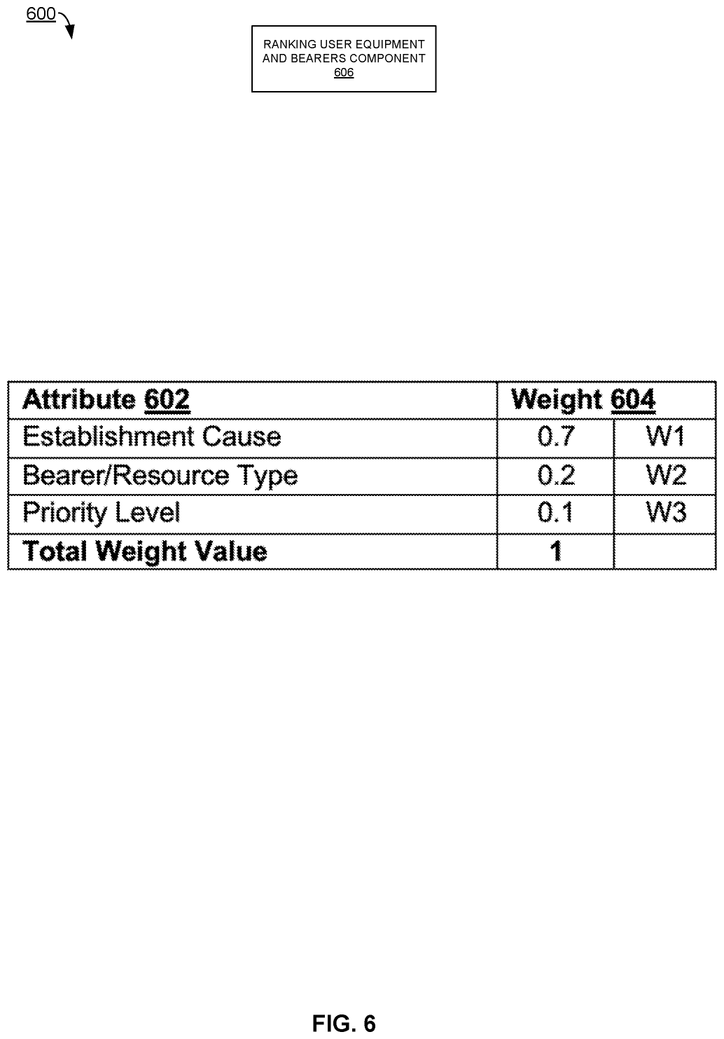

FIG. 6 illustrates an example table 600 of ranking parameter weights, and that can facilitate ranking user equipment and bearers, in accordance with an embodiment of this disclosure. In some examples, parts of table 600 can be used by ranking user equipment and bearers component 108 of FIG. 1, or ranking user equipment and bearers component 606 (which can be similar to ranking user equipment and bearers component 108), as part of facilitating ranking user equipment and bearers.

Table 600 comprises attribute 602 and weight 604.

Determining weights of key UE and DRB attributes can be implemented as follows. Chosen attributes that identify a nature of a UE and how the traffic for these UEs within DRBs are treated E2E. Based on a degree of qualitative influence of these parameters on a UE and a Bearer, a weight for each of these attributes can be derived.

The following example weights can be used. A UE attribute “RRC Establishment Cause” that is communicated to gNodeB during RRC connection setup can be given 70% of the weight due to its high degree of qualitative influence on the type of connection (e.g., Emergency, or High-Priority-Access).

The remaining 30% can be split between bearer level attributes Resource/Bearer Type and Priority Level.

“Bearer Type” can be given a 20% weight, which can determine a type of E2E treatment the packet on this bearer receives, based on whether it is a Delay Critical GBR, GBR, or Non-GBR.

“Priority Level” can be given a 10% weight, which can give a relative importance of a QoS Flow E2E.

The following table can summarize weights assigned to each of these parameters. These weights, along with the relative priority as described above can aid in determining a Bearer Rank and a UE Rank.

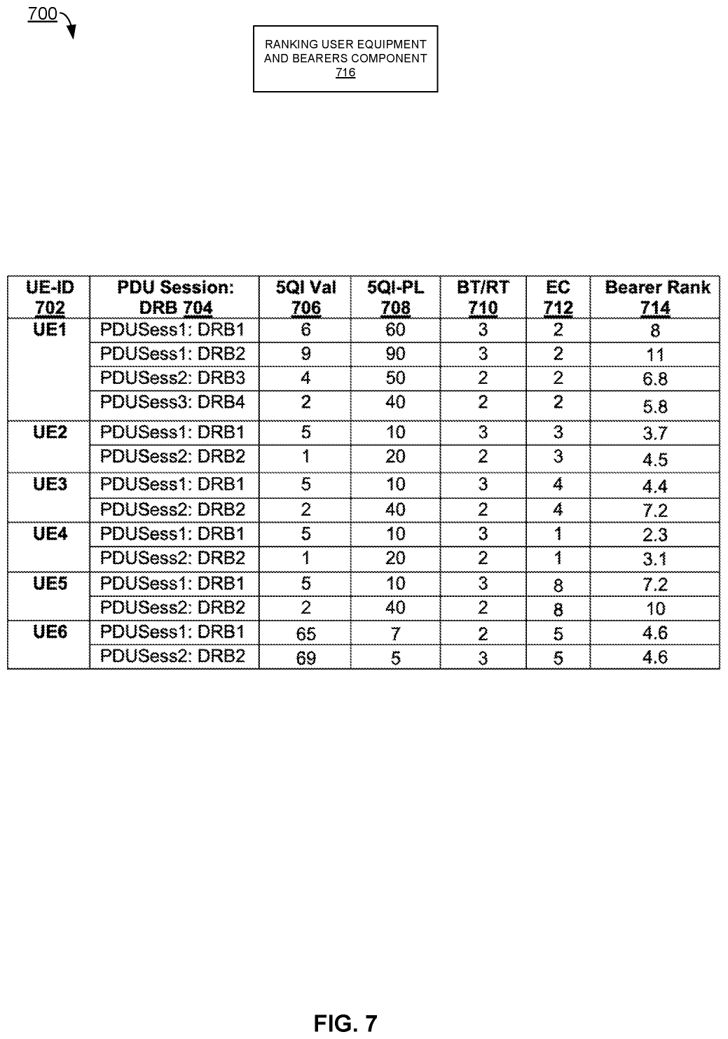

FIG. 7 illustrates an example table of bearer rankings, and that can facilitate ranking user equipment and bearers, in accordance with an embodiment of this disclosure. In some examples, parts of table 700 can be used by ranking user equipment and bearers component 108 of FIG. 1, or ranking user equipment and bearers component 716 (which can be similar to ranking user equipment and bearers component 108), as part of facilitating ranking user equipment and bearers.

Table 700 comprises UE identifier (UE-ID) 702, PDU session: DRB 704, 5QI value 706, 5QI priority level (5QI-PL) 708, bearer type/resource type (BT/RT 710), RRC establishment cause (EC) 712, and bearer rank 714. In some examples, the bearer ranking of table 700 can be based on the information of table 600 of FIG. 6.

A bearer ranking within a UE methodology can be implemented as follows. RRC Establishment Cause (A1), Bearer Type (A2) and Priority Level (A3) can be selected as possible influential parameters for DRB and UE Ranking.

W1, W2 and W3 can be the weights corresponding to RRC Establishment Cause, Bearer Type and Priority Level, respectively.

Bearer Rank can be determined as:

$$Bearer Rank = \{ ( A 1 * W 1 ) + ( A 2 * W 2 ) + ( A 3 * W 3 ) \}$$

Where additional qualitative attributes are considered that satisfies the relation as described above, then bearer rank can be determined as

$$Bearer Rank = \{ ( A 1 * W 1 ) + ( Am * Wm ) + … + ( A 2 * W 2 ) + ( A 3 * W 3 ) + … + ( An * Wn ) \}$$

Bearer Rank can be an indicator of relative bearer importance which can be used to rank a bearer qualitatively.

Based on above determination, and in some examples, Bearer Rank can range from 1 to 21, where 1 is the highest priority and 21 is the lowest priority.

This table depicts computed Bearer Ranks of UEs having multiple bearers, and each bearer having different attributes and values.

Weights for future qualitative attributes can be implemented as follows. There can be other qualitative attributes (e.g., An, Am) which can have influence on behaviors of a bearer and a UE.

These attributes can be factored into deriving the UE and Bearer Rank.

In some examples, simulations can be conducted to derive the extent of qualitative influence the attributes have on the Bearer and UE.

Depending on the degree of qualitative influence that these attributes exhibit on UE and Bearers, weights for attributes (Wn, Wm) can be determined.

In some examples, the attributes-depending on the weights they assume based on qualitative influence—can be determined to satisfy the following.

Take an example where attribute Am is found to exhibit a qualitative influence between A1 and A2, with An having the least influence of all attributes. Then the equations that the weights satisfy can be:

$$W 1 ( ECW ) > Wm ( AmW ) > … > W 2 ( BTW ) > W 3 ( PLW ) > … > Wn ( AnW )$$

$$W 1 ( ECW ) + Wm ( AmW ) + … + W 2 ( BTW ) + W 3 ( PLW ) + … + Wn ( AnW ) = 1$$

This is one example of how weights for qualitative attributes can be generalized, and it can be appreciated that other examples can be implemented in conjunction with the present techniques. For example, the placement of Wm (Am_{w}) and Wn (An_{w}) relative to other weighted attributes can differ (based on the determined weights), and more or fewer than two other qualitative attributes can be used.

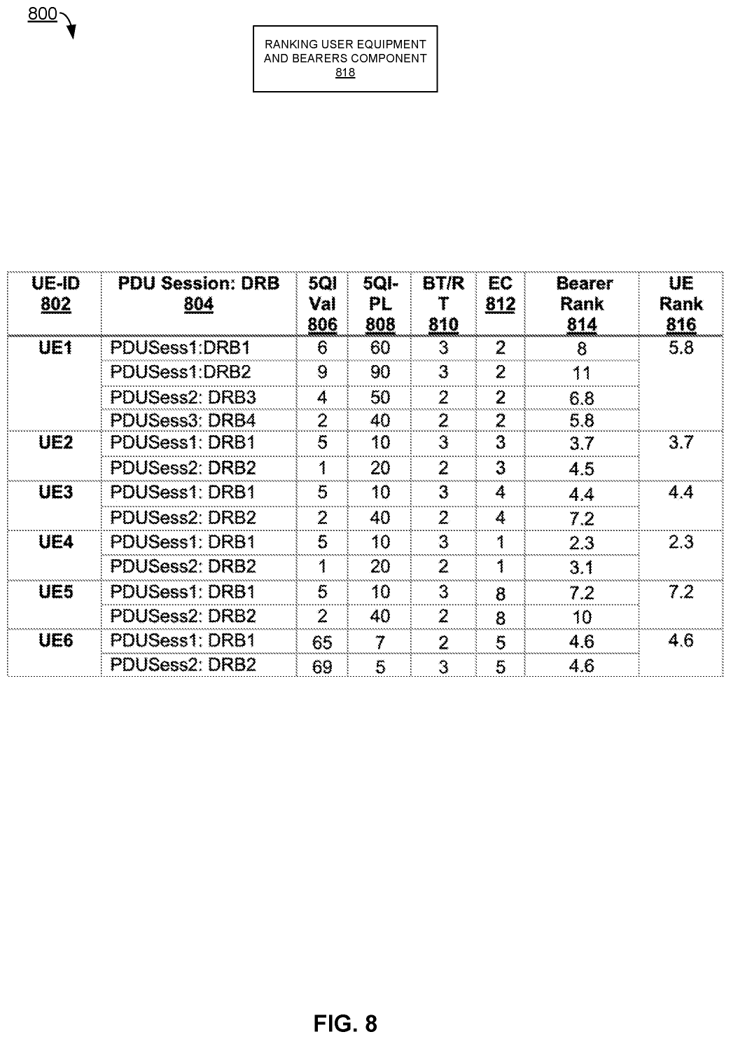

FIG. 8 illustrates an example table 800 of UE rankings, and that can facilitate ranking user equipment and bearers, in accordance with an embodiment of this disclosure. In some examples, parts of table 800 can be used by ranking user equipment and bearers component 108 of FIG. 1, or ranking user equipment and bearers component 808 (which can be similar to ranking user equipment and bearers component 108), as part of facilitating ranking user equipment and bearers.

Table 800 comprises UE-ID 802, PDU session: DRB 804, 5QI value 806, 5QI-PL 808, BT/RT 810, E C 812, bearer rank 814, and UE rank 814. In some examples, the UE ranking of table 800 can be based on the information of table 700 of FIG. 7.

A UE ranking methodology within a gNodeB can be implemented as follows.

Bearer Ranks can be derived for all established bearers of UEs using the weighted average compute methodology described above.

A UE rank can be determined as a Least Rank amongst the Bearer Ranks of all the Established Bearers/DRBs within a UE.

UE rank=min (Bearer Rank 1, Bearer Rank 2, . . . , Bearer Rank n)
Where n is number of DRBs established within the UE

Based on above determination, a UE Rank can range from 1 to 21, where 1 is the highest priority and 21 is the lowest priority

Using this methodology, a sorted list of UE Ranks can be stored and maintained within gNodeB and used for scenarios in prioritizing UEs.

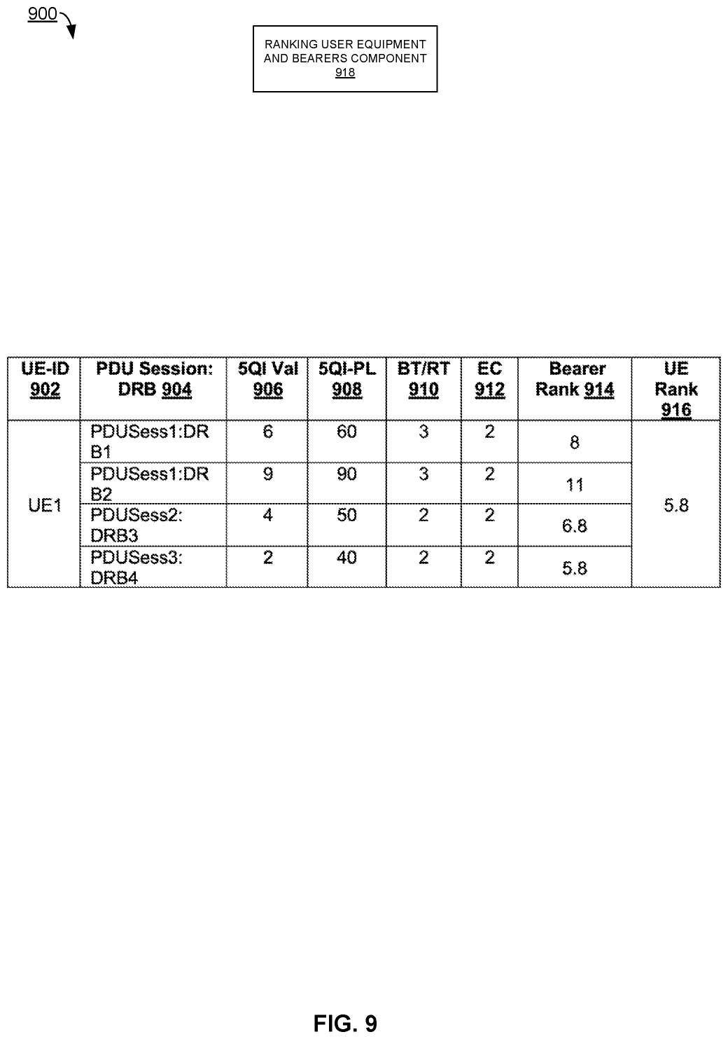

FIG. 9 illustrates an example table 900 of a bearer rank data set for a UE, and that can facilitate ranking user equipment and bearers, in accordance with an embodiment of this disclosure. In some examples, parts of table 900 can be used by ranking user equipment and bearers component 108 of FIG. 1, or ranking user equipment and bearers component 908 (which can be similar to ranking user equipment and bearers component 108), as part of facilitating ranking user equipment and bearers.

Table 900 comprises UE-ID 902, PDU session: DRB 904, 5QI value 906, 5QI-PL 908, BT/RT 910, EC 912, bearer rank 914, and UE rank 914.

Dynamic ranking updates can be implemented as follows. It can be that a bearer's rank can to be updated for dynamic changes that the bearer undergoes. Similarly, the UE Ranks can to reflect all Bearer addition, modification, or deletion within the UE.

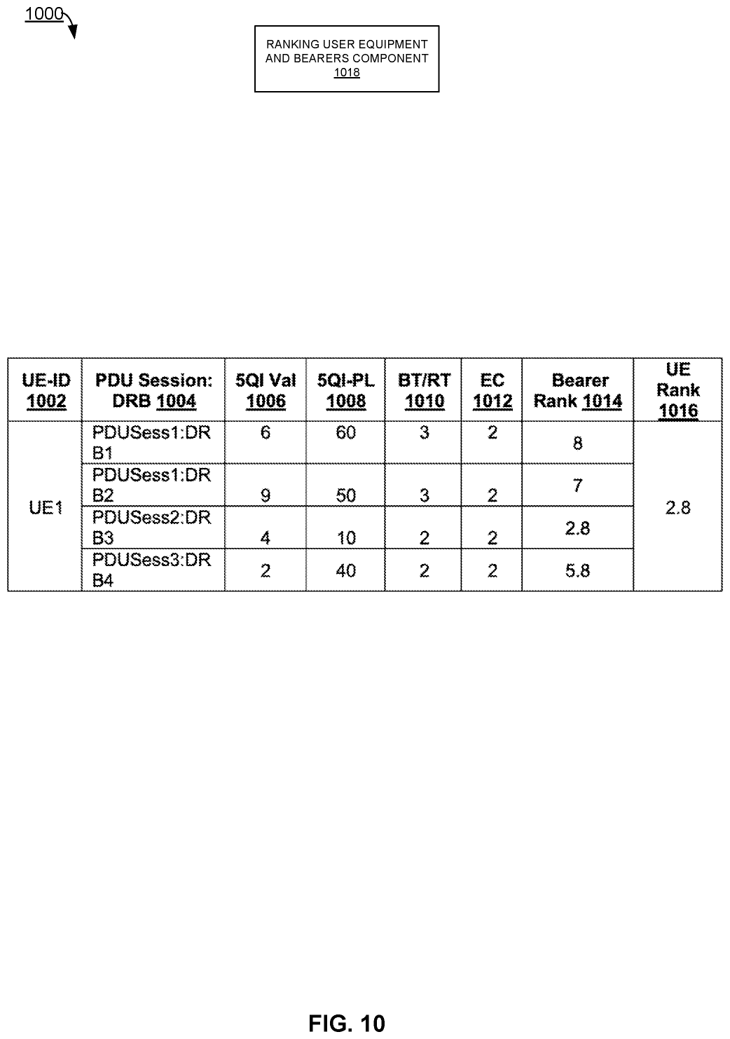

FIG. 10 illustrates an example table 1000 of UE ranking, and that can facilitate ranking user equipment and bearers, in accordance with an embodiment of this disclosure. In some examples, parts of table 1000 can be used by ranking user equipment and bearers component 108 of FIG. 1, or ranking user equipment and bearers component 1008 (which can be similar to ranking user equipment and bearers component 108), as part of facilitating ranking user equipment and bearers.

Table 1000 comprises UE-ID 1002, PDU session: DRB 1004, 5QI value 1006, 5QI-PL 1008, BT/RT 1010, EC 1012, bearer rank 1014, and UE rank 1014.

Dynamic ranking updates due to bearer ranking attribute modifications can be implemented as follows. A Bearer Rank update can be triggered due to modification of the Priority Level.

In this example, UE1 has 4 DRBs and each have different PL and Bearer Type, so the rank for each bearer is different.

Relative to FIG. 9, in FIG. 10, the Priority Level for DRB2 and DRB3 is modified as follows:
DRB 2: Attribute: PL: 90 to 50
DRB 3: Attribute: PL: 50 to 10

Then the Bearer and UE Ranks can change as in table 1000.

It can be seen that UE Rank improves as well as individual bearer ranks of DRB 2 and DRB 3.

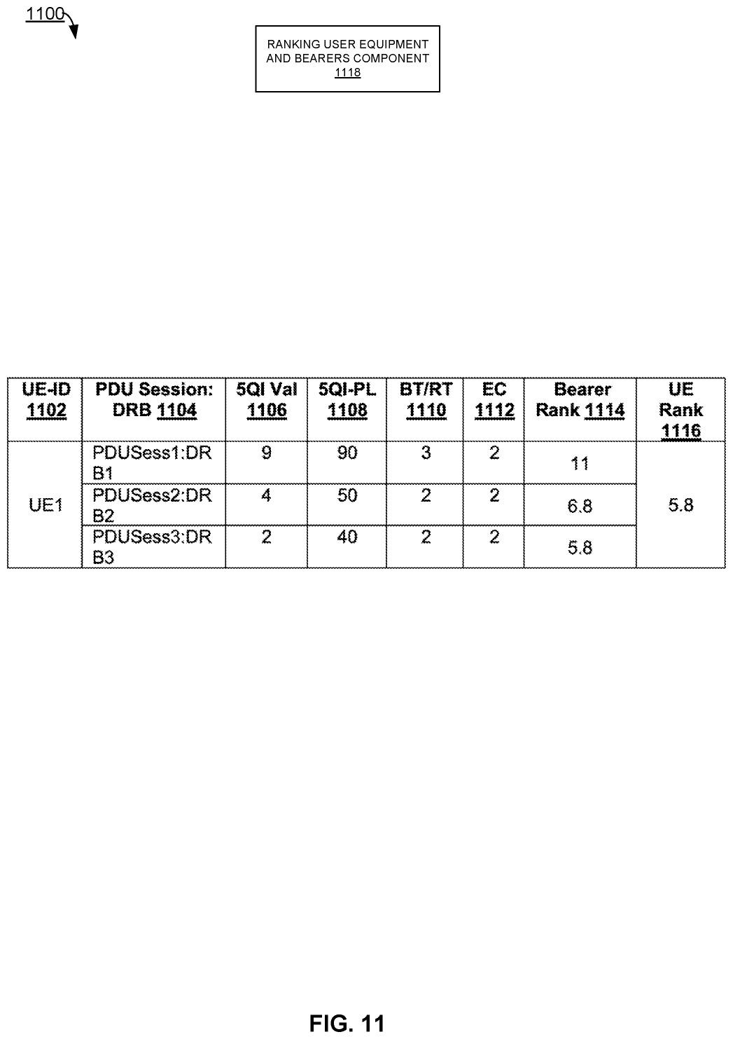

FIG. 11 illustrates an example table of a UE rank data set, and that can facilitate ranking user equipment and bearers, in accordance with an embodiment of this disclosure. In some examples, parts of table 1100 can be used by ranking user equipment and bearers component 108 of FIG. 1, or ranking user equipment and bearers component 1118 (which can be similar to ranking user equipment and bearers component 108), as part of facilitating ranking user equipment and bearers.

Table 1100 comprises UE-ID 1102, PDU session: DRB 1104, 5QI value 1106, 5QI-PL 1108, BT/RT 1110, EC 1112, bearer rank 1114, and UE rank 1116.

Dynamic ranking updates due to Bearer ADD/DEL can be implemented as follows.

Table 1100 can highlight the dynamic rank updates for a UE due to Addition/Deletion of a bearer.

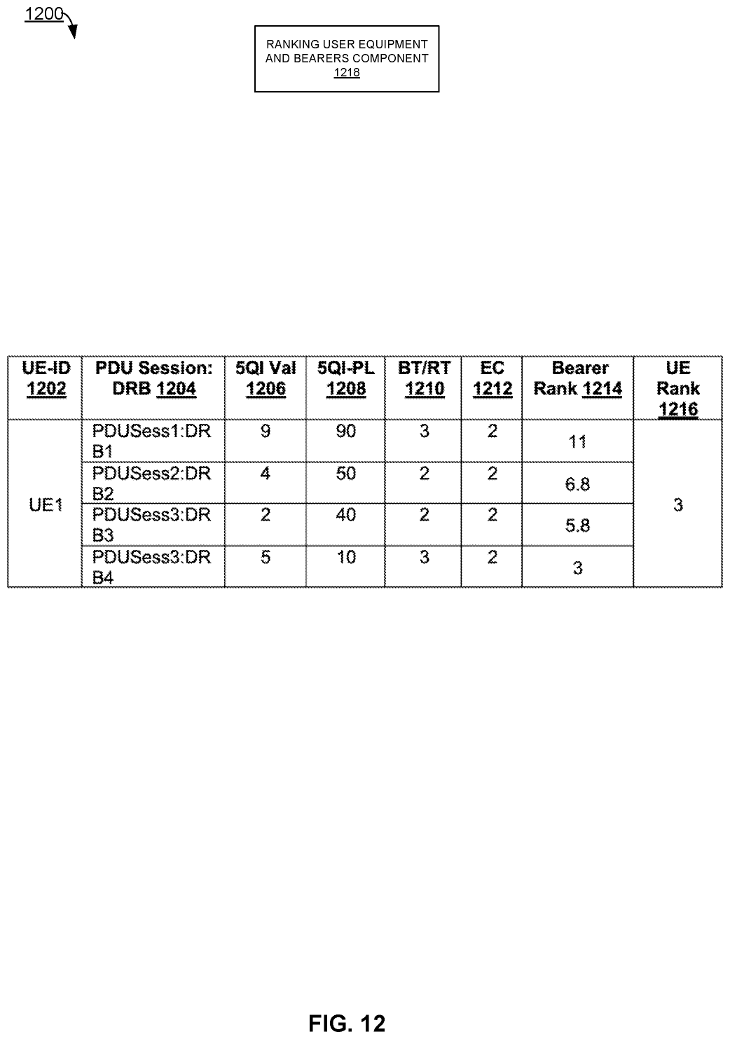

FIG. 12 illustrates an example table 1200 of a UE rank update due to a bearer addition, and that can facilitate ranking user equipment and bearers, in accordance with an embodiment of this disclosure. In some examples, parts of table 1200 can be used by ranking user equipment and bearers component 108 of FIG. 1, or ranking user equipment and bearers component 1208 (which can be similar to ranking user equipment and bearers component 108), as part of facilitating ranking user equipment and bearers.

Table 1200 comprises UE-ID 1202, PDU session: DRB 1204, 5QI value 1206, 5QI-PL 1208, BT/RT 1210, EC 1212, bearer rank 1214, and UE rank 1214.

If a new bearer, DRB 4, is added relative to table 1100 of FIG. 11, this can impact UE Rank, as shown in table 1200.

In this example, an addition of DRB4 has influenced the UE rank since it has better Bearer Rank compared to other DRBs.

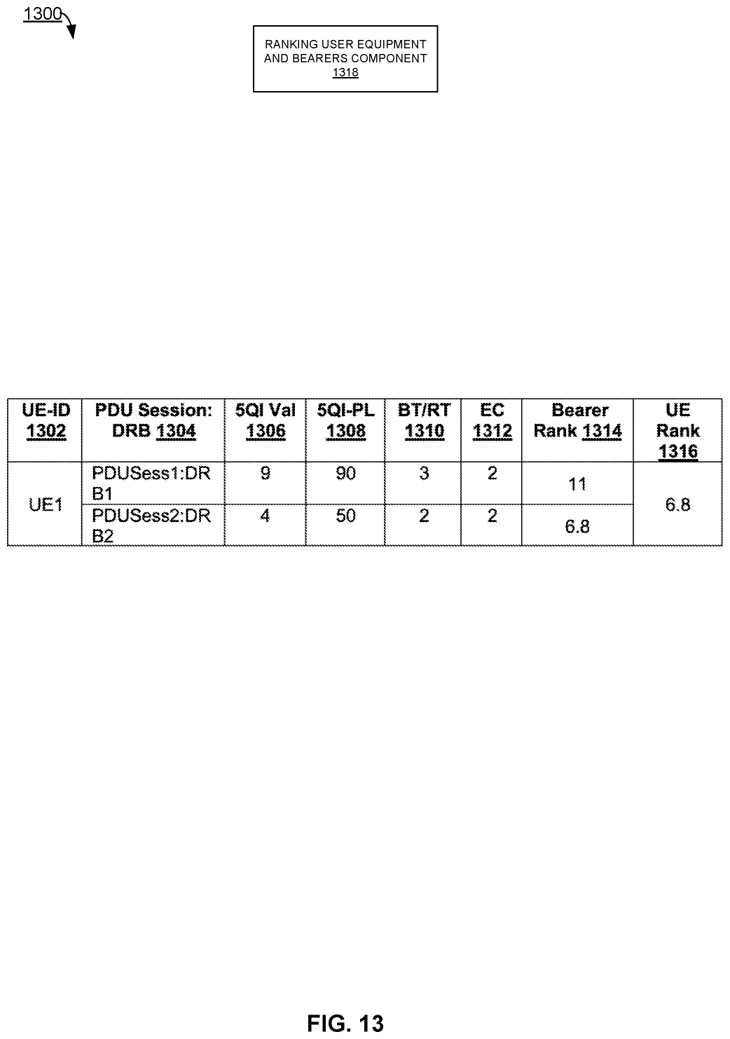

FIG. 13 illustrates an example table 1300 of a UE rank update due to a bearer deletion, and that can facilitate ranking user equipment and bearers, in accordance with an embodiment of this disclosure. In some examples, parts of table 1300 can be used by ranking user equipment and bearers component 108 of FIG. 1, or ranking user equipment and bearers component 1308 (which can be similar to ranking user equipment and bearers component 108), as part of facilitating ranking user equipment and bearers.

Table 1300 comprises UE-ID 1302, PDU session: DRB 1304, 5QI value 1306, 5QI-PL 1308, BT/RT 1310, EC 1312, bearer rank 1314, and UE rank 1314.

In the same scenario, if PDUSess3 gets released, this can still have an impact on UE rank since DRB4 was the best ranked bearer, and now the UE will be ranked to next smallest value of bearer rank, which is DRB2.

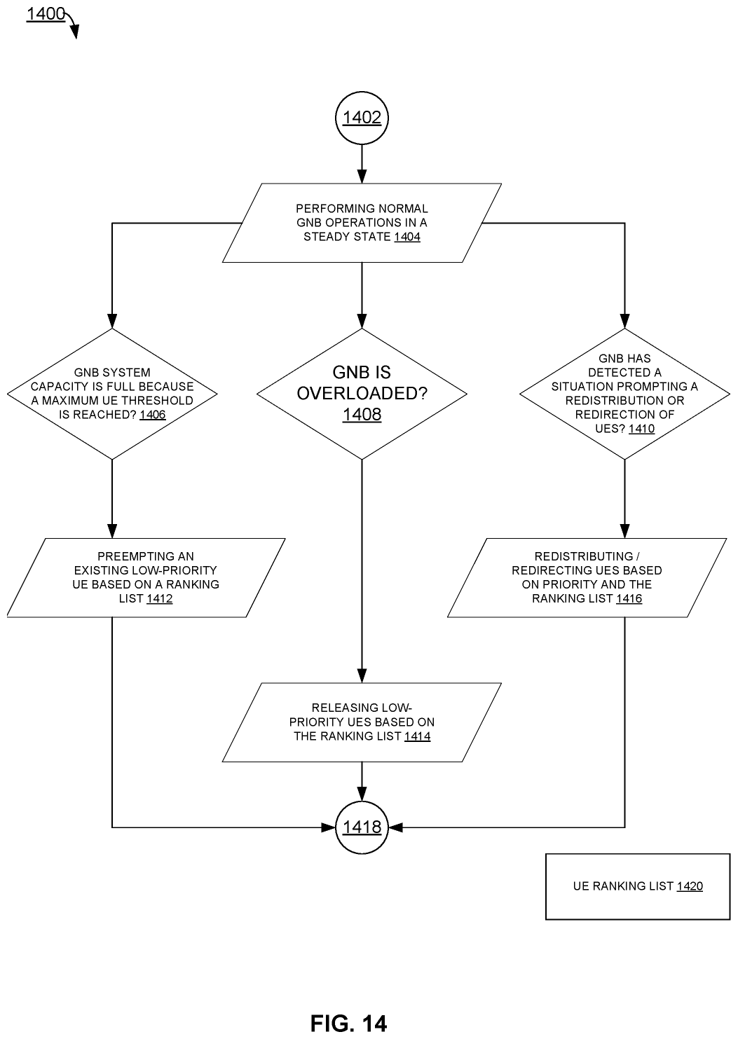

FIG. 14 illustrates an example process flow for a gNodeB running at high load with a ranked UE list, and that can facilitate ranking user equipment and bearers, in accordance with an embodiment of this disclosure. In some examples, one or more embodiments of process flow 1400 can be implemented by ranking user equipment and bearers component 108 of FIG. 1, ranking user equipment and bearers component 1422 (which can be similar to ranking user equipment and bearers component 108), or computing environment 1800 of FIG. 18.

It can be appreciated that the operating procedures of process flow 1400 are example operating procedures, and that there can be embodiments that implement more or fewer operating procedures than are depicted, or that implement the depicted operating procedures in a different order than as depicted. In some examples, process flow 1400 can be implemented in conjunction with one or more embodiments of one or more of process flow 1500 of FIG. 15, process flow 1600 of FIG. 16, and/or process flow 1700 of FIG. 17.

Process flow 1400 begins with 1402, and moves to operation 1404.

Operation 1404 depicts performing normal gNB operations in a steady state. This can be similar to operation 204 of FIG. 2.

After operation 1404, process flow 1400 moves to operation 1406, 1408, or 1410, depending on a condition that is detected.

Operation 1406 depicts determining whether gNB system capacity is full because a maximum UE threshold is reached. This can be similar to operation 206 of FIG. 2.

Examples of link loss scenarios as previously described can be as follows. One example scenario can involve UE preemption. When system capacity is reached, and if there is an incoming emergency user to admit, in an absence of a ranked list of UEs, if a gNodeB decides to preempt an existing UE randomly, there can be a chance that a high-priority UE is released.

After operation 1406, process flow 1400 moves to operation 1412.

Operation 1408 depicts determining whether the gNB is overloaded. This can comprise gNB system resources such as central processing unit (CPU) and memory being almost full. This can be similar to operation 208 of FIG. 2.

Another example scenario can involve congestion control. When an overload condition is detected in a gNodeB, and UEs are to be released to mitigate this situation, higher-priority users can get released instead of low-priority ones.

After operation 1408, process flow 1400 moves to operation 1414.

Operation 1410 depicts determining whether the gNB has detected a situation prompting a redistribution or redirection of UEs. This can be similar to operation 210 of FIG. 2.

Another example scenario can involve UE relocation or redistribution. When a link loss is detected between components, it can be that a gNodeB cannot take a fair decision to relocate high-priority UEs to other serving components. For example, if a link loss is detected between CUCP and CUUP, it can be that UEs can be relocated from one CUUP to another CUUP that is connected to the same CUCP.

After operation 1410, process flow 1400 moves to operation 1416.

Operation 1412 depicts preempting an existing low-priority UE based on a ranking list. This ranking list can be UE ranking list 1420, which ranks UEs as described herein.

After operation 1412, process flow 1400 moves to 1418, where process flow 1400 ends.

Operation 1414 depicts releasing low-priority UEs based on the ranking list.

After operation 1414, process flow 1400 moves to 1418, where process flow 1400 ends.

Operation 1416 depicts redistributing/redirecting UEs based on priority and the ranking list.

After operation 1416, process flow 1400 moves to 1418, where process flow 1400 ends.

In contrast to process flow 200 of FIG. 2 where a UE ranking list is not implemented, according to the present techniques and in process flow 1400, a gNodeB can dynamically build and maintain a sorted list of UEs based on ranks, and this list is available during the life cycle of a gNodeB, then the gNodeB can make informed, unbiased, and fair decisions in these- and other-situations.

The present techniques can be viewed relative to prior approaches as follows. In existing standards, it can be that there are only references for how to prioritize QoS Flow and their preemption capabilities and vulnerabilities (preemptable). Allocation and Retention Priority IE can be suggested as one of the mechanisms for prioritizing a QoS flow over another, and there can be disclosure of how one QoS flow can preempt other existing flows, but it can be that this information is not enough to “Qualitatively Rank” a bearer against each other. Additionally, it can be that this does not give any idea about priority/rank of UEs within gNodeB.

In existing standards, it can be that there is no standardized way to prioritize UEs and rank the bearers within UE. Hence certain dynamic decisions that a gNB takes in various situations might not be the accurate decision.

As a remedy for these shortcomings with prior approaches, the present techniques can be helpful in making unbiased decisions that are more accurate and faster in various runtime scenarios.

In some examples, implementing the present techniques can offer the following benefits. Ranks can be determined for established bearers within a UE. Based on bearer ranks, a UE rank can be derived within a gNodeB.

Then, the following example use cases can be implemented. When a gNodeB is operating at full system capacity, priority user admission can be performed by preempting low priority users, based on a UE rank list.

When link loss is detected at a subcomponent level (e.g., an E1 interface went down between CU-CP and CU-UP), instead of releasing all subscribers, a gNodeB can utilize a UE rank list to provide a differentiated service by relocating priority users to alternative serving sub-components.

When an overload condition is detected, a UE rank list can be utilized to release low priority users with appropriate cause indicated to them to ease the overload situation within a gNodeB.

The present techniques can be applied by an operator in a RAN disaggregated architecture at different examples, such as a slice level, a cell level, and a system level.

The present techniques can be implemented to offer priority service to subscribers/UEs based on the dynamic ranking of UEs within a gNodeB.

In some examples, a priority level attribute change of a bearer triggers a bearer rank re-determination, and a change in other attributes do not trigger a bearer rank re-determination. It can be that a change in bearer rank can result in a UE rank change. An addition or a deletion of a bearer within a UE can result in a dynamic re-determination of a UE rank.

The present techniques can be implemented to facilitate the following aspects in contrast to prior approaches: how to derive a ranked priority in case of 5G disaggregated system; a choice of the constraints in 5G disaggregated system that can qualitatively determine the unique properties of a Bearer and a UE based on a degree qualitive influence of the attributes; and dynamically ranking updates.

### Example Process Flows

FIG. 15 illustrates an example process flow 1500 that can facilitate ranking user equipment and bearers, in accordance with an embodiment of this disclosure. In some examples, one or more embodiments of process flow 1500 can be implemented by ranking user equipment and bearers component 108 of FIG. 1, or computing environment 1800 of FIG. 18.

It can be appreciated that the operating procedures of process flow 1500 are example operating procedures, and that there can be embodiments that implement more or fewer operating procedures than are depicted, or that implement the depicted operating procedures in a different order than as depicted. In some examples, process flow 1500 can be implemented in conjunction with one or more embodiments of one or more of process flow 1400 of FIG. 14, process flow 1600 of FIG. 16, and/or process flow 1700 of FIG. 17.

Process flow 1500 begins with 1502, and moves to operation 1504.

Operation 1504 depicts, for respective user equipment of a group of user equipment for which broadband cellular communications are being facilitated via a network comprising the system, determining respective establishment causes, determining respective bearer types, and determining respective priority levels, wherein a first weight associated with the respective establishment causes is greater than a second weight associated with the respective bearer types, and wherein the second weight is greater than a third weight associated with a priority level. Using the example of FIG. 1, this can comprise with gNB 102 communicating with multiple instances of UEs 110 via broadband cellular communications. gNB 102 can determine an establishment cause, bearer type, and priority level for each UE of UEs 110.

In some examples, a priority level can be implemented as follows. A core network of the network can provide a priority level for a bearer. Where the core network does not provide the priority level, a default priority level that is associated with a QoS for the bearer can be used instead.

After operation 1504, process flow 1500 moves to operation 1506.

Operation 1506 depicts ranking the respective user equipment based on the respective establishment causes, the respective bearer types, the respective priority levels, the first weight, the second weight, and the third weight to produce respective rankings of the respective user equipment. In some examples, the ranking can be similar to that depicted in table 800 of FIG. 8, using weights similar to those depicted in table 600 of FIG. 6.

In some examples, a first user equipment of the group of user equipment comprises a first bearer and a second bearer, and operation 1506 comprises determining a first bearer priority value based on a first bearer type of the respective bearer types associated with the first bearer, and a first priority level of respective priority levels associated with the first bearer, determining a second bearer priority value based on a second bearer type of the respective bearer types associated with the second bearer, and a second priority level of respective priority levels associated with the second bearer; and determining a user equipment priority value based on the first bearer priority value, the second bearer priority value, and a first establishment cause of the establishment causes that is associated with the first user equipment, wherein the first user equipment is ranked among the respective user equipment according to the user equipment priority value. That is, a UE can comprise multiple bearers, a ranking score can be determined for each bearer, and a UE's highest priority bearer score can be the UE's overall score for ranking.

An establishment cause can be a UE-level attribute so can be the same for all bearers within a UE. Given that, it can be that an establishment cause is used to rank a UE but is not used to determine a bearer value within the UE.

After operation 1506, process flow 1500 moves to operation 1508.

Operation 1508 depicts, in response to determining that a serving-capacity criterion is satisfied with respect to the group of user equipment and based on the respective rankings, prioritizing service offered to the respective user equipment. In some examples, this can be similar to process flow 1400 of FIG. 14.

For example, where it is determined in operation 1406 that gNB system capacity is full because a maximum UE threshold is reached, then an existing low-priority UE can be preempted based on the ranking list of operation 1506 and as part of operation 1412.

For example, where it is determined in operation 1408 that the gNB is overloaded, then a low-priority UE can be released based on the ranking list of operation 1506 and as part of operation 1414.

For example, where it is determined in operation 1410 that the gNB has detected a situation prompting a redistribution or redirection of UEs, then UEs can be redistributed/redirected based on the ranking list of operation 1506 and as part of operation 1416.

In some examples, the serving-capacity criterion identifies that an available system capacity of the system is below a threshold value, and prioritizing the service offered to the respective user equipment based on the respective rankings comprises preempting a first user equipment of the group of user equipment based on a first ranking of a user equipment in the respective rankings satisfying a low-priority criterion. This can be implemented in a similar manner as operations 1406 and 1412 of FIG. 14.

In some examples, the serving-capacity criterion identifies that a number of user equipment in the group of user equipment has reached a threshold value, and wherein prioritizing the service offered to the respective user equipment based on the respective rankings comprises preempting a first user equipment of the group of user equipment based on a first ranking of a user equipment in the respective rankings. This can be implemented in a similar manner as operations 1406 and 1412 of FIG. 14.

In some examples, the serving-capacity criterion identifies that available processing resources of the system are below a threshold value, and wherein prioritizing the service offered to the respective user equipment based on the respective rankings comprises releasing a first user equipment of the group of user equipment based on a first ranking of a user equipment in the respective rankings. This can be implemented in a similar manner as operations 1408 and 1414 of FIG. 14.

In some examples, the serving-capacity criterion identifies that available memory resources of the system are below a threshold value, and prioritizing the service offered to the respective user equipment based on the respective rankings comprises releasing a first user equipment of the group of user equipment based on a first ranking of a user equipment in the respective rankings. This can be implemented in a similar manner as operations 1408 and 1414 of FIG. 14.

In some examples, the serving-capacity criterion indicates redistributing at least one user equipment of the group of user equipment, and prioritizing the service offered to the respective user equipment based on the respective rankings comprises redistributing a first user equipment of the group of user equipment based on a first ranking of a user equipment in the respective rankings. This can be implemented in a similar manner as operations 1410 and 1416 of FIG. 14.

This redistributing can be applied to differing conditions where redistribution of UEs is involved. For example, this can occur where link loss is detected at a subcomponent level, such as when an E1 control interface between a CU-CP and a CU-UP goes down. Instead of releasing all subscribers, a gNodeB can utilize a UE ranking list to provide differentiated service by relocating priority users to alternate serving sub-components, in a case of link loss.

In some examples, the serving-capacity criterion indicates redirecting at least one user equipment that attempts to attach to the system, and prioritizing the service offered to the respective user equipment based on the respective rankings comprises redirecting a first user equipment of the group of user equipment based on a first ranking of a user equipment in the respective rankings. This can be implemented in a similar manner as operations 1410 and 1416 of FIG. 14.

After operation 1508, process flow 1500 moves to 1510, where process flow 1500 ends.

FIG. 16 illustrates an example process flow 1600 that can facilitate ranking user equipment and bearers, in accordance with an embodiment of this disclosure. In some examples, one or more embodiments of process flow 1600 can be implemented by ranking user equipment and bearers component 108 of FIG. 1, or computing environment 1800 of FIG. 18.

It can be appreciated that the operating procedures of process flow 1600 are example operating procedures, and that there can be embodiments that implement more or fewer operating procedures than are depicted, or that implement the depicted operating procedures in a different order than as depicted. In some examples, process flow 1600 can be implemented in conjunction with one or more embodiments of one or more of process flow 1400 of FIG. 14, process flow 1600 of FIG. 16, and/or process flow 1700 of FIG. 17.

Process flow 1600 begins with 1602, and moves to operation 1604.

Operation 1604 depicts facilitating broadband cellular communications with a group of user equipment. In some example, operation 1604 can be implemented in a similar manner as operation 1504 of FIG. 15, as applied to facilitating broadband cellular communications.

After operation 1604, process flow 1600 moves to operation 1606.

Operation 1606 depicts, for each user equipment of the group of user equipment, determining a respective establishment cause, a respective bearer type, and a respective priority level. In some example, operation 1606 can be implemented in a similar manner as operation 1504 of FIG. 15, as applied to determining this information.

After operation 1606, process flow 1600 moves to operation 1608.

Operation 1608 depicts ranking each of the user equipment of the group of user equipment based on the respective establishment cause, the respective bearer type, and the respective priority level to produce ranks. In some examples, operation 1608 can be implemented in a similar manner as operation 1506 of FIG. 15.

In some examples, the ranking is performed based on a first weight associated with establishment causes, a second weight associated with bearer types, and a third weight associated with a priority level. In some examples, the first weight is greater than the second weight, and wherein the second weight is greater than the third weight.

In some examples, the ranks are first ranks, the first ranks comprise a user equipment score for a user equipment of the group of user equipment, the user equipment score is based on a first bearer score that corresponds to a first bearer of the user equipment and a second bearer score that corresponds to a second bearer of the user equipment, operation 1508 comprises, based on removing the first bearer, determining an updated user equipment score based on the second bearer score and independent of the first bearer score, and updating the ranks based on the updated user equipment score. That is bearer rankings can be dynamically updated based on removing a bearer.

In some examples, the ranks are first ranks, the first ranks comprise a user equipment score for a user equipment of the group of user equipment, the user equipment score is based on a first bearer score that corresponds to a first bearer of the user equipment and a second bearer score that corresponds to a second bearer of the user equipment, and operation 1508 comprises, based on adding a third bearer that corresponds to the user equipment, determining a third bearer score that corresponds to the third bearer, determining an updated user equipment score based on the first bearer score, the second bearer score, and the third bearer score, and updating the ranks based on the updated user equipment score.

After operation 1608, process flow 1600 moves to operation 1610.

Operation 1610 depicts, in response to determining that a serving-capacity criterion is satisfied with respect to the group of user equipment, prioritizing service offered to the respective user equipment based on the ranks. In some examples, operation 1610 can be implemented in a similar manner as operation 1508 of FIG. 15.

After operation 1610, process flow 1600 moves to 1612, where process flow 1600 ends.

FIG. 17 illustrates an example process flow 1700 that can facilitate ranking user equipment and bearers, in accordance with an embodiment of this disclosure. In some examples, one or more embodiments of process flow 1700 can be implemented by ranking user equipment and bearers component 108 of FIG. 1, or computing environment 1800 of FIG. 18.

It can be appreciated that the operating procedures of process flow 1700 are example operating procedures, and that there can be embodiments that implement more or fewer operating procedures than are depicted, or that implement the depicted operating procedures in a different order than as depicted. In some examples, process flow 1700 can be implemented in conjunction with one or more embodiments of one or more of process flow 1400 of FIG. 14, process flow 1500 of FIG. 15, and/or process flow 1600 of FIG. 16. Process flow 1700 begins with 1702, and moves to operation 1704.

Operation 1704 depicts, for respective user equipment of a group of user equipment, determining respective establishment causes, respective bearer types, and respective priority levels. In some example, operation 1704 can be implemented in a similar manner as operation 1504 of FIG. 15, as applied to facilitating broadband cellular communications.

In some examples, the respective establishment causes comprise an emergency event, a high priority access event, or a mo-voice event. In some examples, the respective bearer types comprise a delay critical guaranteed bit rate type, a guaranteed bit rate type, or a non-guaranteed bit rate type.

After operation 1704, process flow 1700 moves to operation 1706.

Operation 1706 depicts ranking the respective user equipment based on the respective establishment causes, the respective bearer types, and the respective priority levels to produce respective ranks. In some examples, operation 1706 can be implemented in a similar manner as operation 1506 of FIG. 15.

In some examples, the respective user equipment are associated with respective groups of one or more bearers, operation 1706 comprises determining respective user equipment ranking scores of the respective user equipment based on respective bearer scores of respective bearers of the respective groups of one or more bearers, wherein ranking the respective user equipment is performed based on the respective user equipment ranking scores. That is, a UE can be ranked based on ranking each of its bearers.

In some examples, the respective user equipment are ranked based on respective quality-of-service levels associated with the respective user equipment. It can be that each bearer of a UE is associated with a QoS level, and a QoS level is associated with a default priority level. Where a priority level is not specified by the core network, this default priority level associated with a QoS level of a bearer can be used in determining a bearer rank (and then a UE rank).

After operation 1706, process flow 1700 moves to operation 1708.

Operation 1708 depicts, in response to determining that a serving-capacity criterion is satisfied with respect to the group of user equipment, prioritizing respective services offered to the respective user equipment based on the respective ranks. In some examples, operation 1708 can be implemented in a similar manner as operation 1508 of FIG. 15.

In some examples, the prioritizing is configurable to be performed at a slice level of the system, at a cell level of the system, or at a system level of the system. That is, the present techniques can be implemented in different hierarchy levels of a RAN disaggregated architecture.

After operation 1708, process flow 1700 moves to 1710, where process flow 1700 ends.

### Example Operating Environment

In order to provide additional context for various embodiments described herein, FIG. 18 and the following discussion are intended to provide a brief, general description of a suitable wireless communications operating environment in which the various embodiments of the embodiment described herein can be implemented.

For example, parts of wireless communications operating environment can be used to implement one or more embodiments of gNB 102 and/or UEs 110 of FIG. 1.

In some examples, wireless communications operating environment can implement one or more embodiments of the process flows of FIGS. 2 and/or 14-17 to facilitate ranking user equipment and bearers.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

FIG. 18 illustrates an example block diagram of a wireless communications operating environment 1800 operable to execute an embodiment of this disclosure. A UE of UE(s) 1804A, UE(s) 1804B, and/or UE(s) 1804N can generally comprise a device used by an end user to access a communications network. A UE can be configured to receive messages from communications network 1806, which can be, for instance, a global communications network such as the Internet.

Messages sent from A UE can be received and processed by core network 1808, which can comprise components of a third-generation (3G), fourth-generation (4G), long-term evolution (LTE), 5G, or other, wireless communication network. Core network 1808 can be configured to establish connectivity between a UE and communications network 1806, such as through facilitating services such as connectivity and mobility management, authentication and authorization, subscriber data management, and policy management. Messages sent between a UE and communications network 1806 can propagate through centralized unit (CU) 1810, distributed unit (DU) 1812, radio unit (RU) 1814, and antenna 1816A, antenna 1816B, or antenna 1816N.

CU 1810 can be configured to process non-real-time RRC and packet data convergence protocol (PDCP) communications. DU 1812 can be configured to process communications transmitted according to radio link control (RLC), medium access control (MAC), and physical (PHY) layers. RU 1814 can be configured to convert radio signals sent to antenna 1816 from digital packets to radio signals, and convert radio signals received from antenna 1816 from radio signals to digital packets.

Antenna 1816A, antenna 1816B, and antenna 1816N (which can comprise a transceiver) can each be configured to send and receive radio waves that are used to convey information. In some examples, each of antenna 1816A, antenna 1816B, and antenna 1816N can facilitate communications according to the same protocol (e.g., 5G) or different protocols.

### CONCLUSION

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, optical disk storage, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a processor; and
a memory that stores executable instructions that, when executed by the processor, facilitate performance of operations, comprising:
for respective user equipment of a group of user equipment for which broadband cellular communications are being facilitated via a network comprising the system,
determining respective establishment causes,
determining respective bearer types, and
determining respective priority levels,
wherein a first weight associated with the respective establishment causes is greater than a second weight associated with the respective bearer types, and wherein the second weight is greater than a third weight associated with a priority level;
ranking the respective user equipment based on the respective establishment causes, the respective bearer types, the respective priority levels, the first weight, the second weight, and the third weight to produce respective rankings of the respective user equipment; and
in response to determining that a serving-capacity criterion is satisfied with respect to the group of user equipment and based on the respective rankings, prioritizing service offered to the respective user equipment.

2. The system of claim 1, wherein a first user equipment of the group of user equipment comprises a first bearer and a second bearer, and wherein the operations further comprise:
determining a first bearer priority value based on a first bearer type of the respective bearer types associated with the first bearer, and a first priority level of respective priority levels associated with the first bearer;
determining a second bearer priority value based on a second bearer type of the respective bearer types associated with the second bearer, and a second priority level of respective priority levels associated with the second bearer; and
determining a user equipment priority value based on the first bearer priority value, the second bearer priority value, and a first establishment cause of the establishment causes that is associated with the first user equipment, wherein the first user equipment is ranked among the respective user equipment according to the user equipment priority value.

3. The system of claim 2, wherein the user equipment priority value corresponds to a higher priority value of the first bearer priority value and the second bearer priority value.

4. The system of claim 1, wherein the serving-capacity criterion identifies that an available system capacity of the system is below a threshold value, and wherein prioritizing the service offered to the respective user equipment based on the respective rankings comprises:
preempting a first user equipment of the group of user equipment based on a first ranking of a user equipment in the respective rankings satisfying a low-priority criterion.

5. The system of claim 1, wherein the serving-capacity criterion identifies that a number of user equipment in the group of user equipment has reached a threshold value, and wherein prioritizing the service offered to the respective user equipment based on the respective rankings comprises:
preempting a first user equipment of the group of user equipment based on a first ranking of a user equipment in the respective rankings.

6. The system of claim 1, wherein the serving-capacity criterion identifies that available processing resources of the system are below a threshold value, and wherein prioritizing the service offered to the respective user equipment based on the respective rankings comprises:
releasing a first user equipment of the group of user equipment based on a first ranking of a user equipment in the respective rankings.

7. The system of claim 1, wherein the serving-capacity criterion identifies that available memory resources of the system are below a threshold value, and wherein prioritizing the service offered to the respective user equipment based on the respective rankings comprises:
releasing a first user equipment of the group of user equipment based on a first ranking of a user equipment in the respective rankings.

8. The system of claim 1, wherein the serving-capacity criterion indicates redistributing at least one user equipment of the group of user equipment, and wherein prioritizing the service offered to the respective user equipment based on the respective rankings comprises:
redistributing a first user equipment of the group of user equipment based on a first ranking of a user equipment in the respective rankings.

9. The system of claim 1, wherein the serving-capacity criterion indicates redirecting at least one user equipment that attempts to attach to the system, and wherein prioritizing the service offered to the respective user equipment based on the respective rankings comprises:
redirecting a first user equipment of the group of user equipment based on a first ranking of a user equipment in the respective rankings.

10. A method, comprising:
facilitating, by a system, broadband cellular communications with a group of user equipment;
for each user equipment of the group of user equipment, determining, by the system, a respective establishment cause, a respective bearer type, and a respective priority level;
ranking, by the system, each of the user equipment of the group of user equipment based on the respective establishment cause, the respective bearer type, and the respective priority level to produce ranks; and
in response to determining that a serving-capacity criterion is satisfied with respect to the group of user equipment, prioritizing, by the system, service offered to the respective user equipment based on the ranks.

11. The method of claim 10, wherein the ranking is performed based on a first weight associated with establishment causes, a second weight associated with bearer types, and a third weight associated with a priority level.

12. The method of claim 11, wherein the first weight is greater than the second weight, and wherein the second weight is greater than the third weight.

13. The method of claim 10, wherein the ranks are first ranks, wherein the first ranks comprise a user equipment score for a user equipment of the group of user equipment, wherein the user equipment score is based on a first bearer score that corresponds to a first bearer of the user equipment and a second bearer score that corresponds to a second bearer of the user equipment, and further comprising:
based on removing the first bearer, determining, by the system, an updated user equipment score based on the second bearer score and independent of the first bearer score; and
updating, by the system, the ranks based on the updated user equipment score.

14. The method of claim 10, wherein the ranks are first ranks, wherein the first ranks comprise a user equipment score for a user equipment of the group of user equipment, wherein the user equipment score is based on a first bearer score that corresponds to a first bearer of the user equipment and a second bearer score that corresponds to a second bearer of the user equipment, and further comprising:
based on adding a third bearer that corresponds to the user equipment, determining, by the system, a third bearer score that corresponds to the third bearer;
determining, by the system, an updated user equipment score based on the first bearer score, the second bearer score, and the third bearer score; and
updating, by the system, the ranks based on the updated user equipment score.

15. A non-transitory computer-readable medium comprising instructions that, in response to execution, cause a system comprising a processor to perform operations, comprising:
for respective user equipment of a group of user equipment, determining respective establishment causes, respective bearer types, and respective priority levels;
ranking the respective user equipment based on the respective establishment causes, the respective bearer types, and the respective priority levels to produce respective ranks; and
in response to determining that a serving-capacity criterion is satisfied with respect to the group of user equipment, prioritizing respective services offered to the respective user equipment based on the respective ranks.

16. The non-transitory computer-readable medium of claim 15, wherein the respective user equipment are associated with respective groups of one or more bearers, and wherein the operations further comprise:
determining respective user equipment ranking scores of the respective user equipment based on respective bearer scores of respective bearers of the respective groups of one or more bearers,
wherein ranking the respective user equipment is performed based on the respective user equipment ranking scores.

17. The non-transitory computer-readable medium of claim 15, wherein the prioritizing is configurable to be performed at a slice level of the system, at a cell level of the system, or at a system level of the system.

18. The non-transitory computer-readable medium of claim 15, wherein the respective establishment causes comprise an emergency event, a high priority access event, or a mobile originated voice event.

19. The non-transitory computer-readable medium of claim 15, wherein the respective bearer types comprise a delay critical guaranteed bit rate type, a guaranteed bit rate type, or a non-guaranteed bit rate type.

20. The non-transitory computer-readable medium of claim 15, wherein the respective user equipment are ranked based on respective quality-of-service levels associated with the respective user equipment.
